(19) United States
(12) Patent Application Publication
(10) Pub. No.: US 2026/0260921 A1
(43) Pub. Date: Sep. 3, 2026

(54) METHOD FOR MANUFACTURING POLYMER ELECTROLYTE MEMBRANE AND MEMBRANE-ELECTRODE ASSEMBLY

(71) Applicant: HEESUNG CATALYSTS CORPORATION, Siheung-si (KR)

(72) Inventors: Inkee PARK, Incheon (KR); Jae Kwang LEE, Incheon (KR); Youngsan YOO, Incheon (KR)

(21) Appl. No.: 18/873,374

(22) PCT Filed: Jun. 13, 2023
(86) PCT No.: PCT/KR2023/008099

§ 371 Date: Dec. 10, 2024

(30) Foreign Application Priority Data
Jun. 17, 2022 (KR) 10-2022-0074410

(51) Int. Cl. H01M 8/1086

(52) U.S. Cl. CPC H01M 8/1093

(57) ABSTRACT

Provided is a method for manufacturing a polymer electrolyte membrane, the method comprising: applying a solvent to a polymer electrolyte membrane having defects on the surface thereof to swell the polymer electrolyte membrane; and applying heat and pressure to the swollen polymer electrolyte membrane

### TECHNICAL FIELD

The present invention relates to a method for manufacturing a polymer electrolyte membrane and a membrane-electrode assembly capable of evenly controlling the surface of a physically defective polymer electrolyte membrane.

### BACKGROUND ART

A fuel cell is a battery cell equipped with a power generation system that directly converts chemical reaction energy such as oxidation/reduction reaction of hydrogen and oxygen contained in hydrocarbon-based fuel materials such as methanol, ethanol, and natural gas into electrical energy and is being spotlighted as a next generation clean energy source that may replace fossil energy due to high energy efficiency and eco-friendliness with low pollutant emission.

This fuel cell may have a stack configuration by stacking unit cells and produce a wide range of outputs and also, exhibit about 4 times to about 10 times higher energy density than a small lithium battery and thus attracts attention as a small and portable power source.

In the fuel cell, a stack substantially generating electricity has a structure of stacking several to tens of the unit cells composed of a membrane-electrode assembly (MEA) and a separator (also, called to be a bipolar plate), wherein the membrane-electrode assembly has a structure of having an oxidation electrode (anode or fuel electrode) and a reduction electrode (cathode or air electrode) respectively formed on both surfaces of an electrolyte membrane.

Meanwhile, there are two main methods for manufacturing membrane-electrode assemblies for fuel cells. First, the CCS (Catalyst Coated Substrate) method is a method of coating a catalyst layer on a substrate, and the CCM (Catalyst Coated Membrane) method is a method of forming a catalyst layer on a polymer electrolyte membrane.

The CCM method is again divided into two methods. The first is a method of directly coating a catalyst layer on a polymer electrolyte membrane (Direct Coating), and the second is a method of first forming a catalyst layer on a substrate and then transferring the catalyst layer to the polymer electrolyte membrane using heat and pressure.

When forming a catalyst layer on a polymer electrolyte membrane, the properties of the polymer electrolyte membrane surface are one of the important requirements to be considered during electrode transfer. When a polymer electrolyte membrane having a sulfonic acid functional group undergoes a decal process at high temperature and pressure while the membrane surface is uneven due to defects, the interface between the catalyst layer and the polymer electrolyte membrane becomes detached, increasing the membrane-electrode interfacial resistance and decreasing performance.

### DISCLOSURE

### Technical Problem

An embodiment provides a method for manufacturing a polymer electrolyte membrane, which can improve the physical stability of the MEA during long-term operation and excellent cell performance by evenly controlling the surface of a physically defective polymer electrolyte membrane while preventing deterioration of the polymer electrolyte membrane, thereby lowering the interfacial resistance between the polymer electrolyte membrane and an electrode.

Another embodiment provides a method for manufacturing a membrane-electrode assembly using the manufactured polymer electrolyte membrane.

### Technical Solution

According to an embodiment, a method for manufacturing a polymer electrolyte membrane includes: applying a solvent to a polymer electrolyte membrane having defects on the surface thereof to swell the polymer electrolyte membrane, and applying heat and pressure to the swollen polymer electrolyte membrane.

The solvent may include water, alcohol, an organic solvent, or a combination thereof.

The solvent may be a mixed solvent including greater than 0 wt % and less than 100 wt % of water and more than 0 wt % and less than 100 wt % of alcohol.

The method for applying the solvent to the polymer electrolyte membrane may include spraying, steam spraying, or a combination thereof.

The swelling may be performed in 1 to 30 seconds.

The polymer electrolyte membrane may have an increase in length by 1% to 20% after swelling compared to its length before swelling.

The polymer electrolyte membrane may have a thickness increase of 1% to 20% after swelling compared to the thickness before swelling.

The applying of heat and pressure may be performed for 1 to 30 seconds.

The applying of heat and pressure may be performed at a temperature of about 20% of an intrinsic glass transition temperature (Tg) of the polymer electrolyte membrane.

The applying of heat and pressure may be performed at a temperature of 110° C. to 130° C.

The applying of heat and pressure may be accomplished by applying a pressure of 50 kg/cm² to 200 kg/cm².

A degree of deterioration in the hydrogen ionic conductivity of the polymer electrolyte membrane before and after the applying of heat and pressure may be less than 5%.

According to another embodiment, a method for manufacturing a membrane-electrode assembly includes coating a composition for forming a catalyst layer on one or both surfaces of the polymer electrolyte membrane manufactured by the method described above.

### Advantageous Effects

The method for manufacturing a polymer electrolyte membrane according to an embodiment of the present invention can prevent deterioration of the polymer electrolyte membrane by evenly controlling the surface of a physically defective polymer electrolyte membrane, thereby lowering the interfacial resistance between the polymer electrolyte membrane and an electrode, and improving excellent cell performance and the physical stability of the MEA during long-term operation.

### DESCRIPTION OF THE DRAWINGS

FIG. 1 is a view showing a manufacturing process of a membrane-electrode assembly according to an embodiment.

FIG. 2 is a view showing a manufacturing process of a membrane-electrode assembly according to conventional art.

FIG. 3 is a photograph of a polymer electrolyte membrane having surface defects and a polymer electrolyte membrane with controlled surface defects in Example 1.

FIG. 4 is a graph showing a swelling degree according to the amount of solvent injected per unit area for controlling a polymer electrolyte membrane having a defect on the surface in Example 1.

FIG. 5 is a graph showing a swelling degree according to the water-alcohol solvent ratio for controlling a polymer electrolyte membrane having surface defects in Example 1.

FIG. 6 is a graph showing a drying rate according to the change in thermocompression time for controlling a polymer electrolyte membrane having a defect on the surface in Example 1.

FIG. 7 is a scanning electron microscope (SEM) photograph of the membrane-electrode assembly manufactured in Example 1.

FIG. 8 is a scanning electron microscope (SEM) photograph of the membrane-electrode assembly manufactured in Comparative Example 1.

FIG. 9 is a current density-voltage graph of the membrane electrode assembly manufactured in Example 1 and Comparative Example 1.

FIG. 10 is a potential-current density graph of the membrane-electrode assembly manufactured in Example 1 and Comparative Example 1.

### BEST MODE

The advantages and features of the present disclosure and the methods for accomplishing the same will be apparent from the embodiments described hereinafter with reference to the accompanying drawings. However, the embodiments should not be construed as being limited to the embodiments set forth herein. Unless otherwise defined, all terms (including technical and scientific terms) used herein have the same meaning as commonly understood by one of ordinary skill in the art. The terms defined in a generally-used dictionary may not be interpreted ideally or exaggeratedly unless clearly defined. In addition, unless explicitly described to the contrary, the word “comprise,” and variations such as “comprises” or “comprising,” will be understood to imply the inclusion of stated elements but not the exclusion of any other elements.

Further, the singular includes the plural unless mentioned otherwise.

A method for manufacturing a polymer electrolyte membrane according to an embodiment includes swelling a polymer electrolyte membrane, and applying heat and pressure to the swollen polymer electrolyte membrane.

The polymer electrolyte membrane includes an ion conductor. The ion conductor may be a cation conductor having a cation exchange group capable of transporting a cation such as a proton, or an anion conductor having an anion exchange group capable of transporting anions such as a hydroxyl ion, carbonate or bicarbonate.

The cation exchange group may be any one selected from the group consisting of a sulfonic acid group, a carboxyl group, a boronic acid group, a phosphoric acid group, an imide group, a sulfonimide group, a sulfonamide group and a combination thereof, and may typically be a sulfonic acid group or a carboxyl group.

The cation conductor may include a cation exchange group, and examples thereof include a fluorine-containing polymer in the main chain; a hydrocarbon-based polymer such as benzimidazole, polyamide, polyamideimide, polyimide, polyacetal, polyethylene, polypropylene, an acrylic resin, polyester, polysulfone, polyether, polyetherimide, polyester, polyethersulfone, polyetherimide, polycarbonate, polystyrene, polyphenylene sulfide, polyetheretherketone, polyetherketone, polyarylethersulfone, polyphosphazene or polyphenylquinoxaline; a partially fluorinated polymer such as a polystyrene-graft-ethylenetetrafluoroethylene copolymer or a polystyrene-graft-polytetrafluoroethylene copolymer; and sulfone imide.

More specifically, when the cation conductor is a proton cation conductor, the polymers may include a cation exchange group selected from the group consisting of a sulfonic acid group, a carboxylic acid group, a phosphoric acid group, a phosphonic acid group, and a derivative thereof in the side chain, specific examples thereof may include a fluorinated polymer including poly(perfluorosulfonic acid), poly(perfluorocarboxylic acid), a copolymer of tetrafluoroethylene and fluorovinyl ether including a sulfonic acid group, a defluorinated sulfurized polyether ketone, or a mixture thereof; a hydrocarbon polymer including sulfonated polyimide (S-PI), sulfonated polyarylethersulfone (S-PAES), sulfonated polyetheretherketone (SPEEK), sulfonated polybenzimidazole (SPBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, and a mixture thereof, but are not limited thereto.

The anion conductor may be a polymer capable of transporting anions such as a hydroxyl ion, carbonate, or bicarbonate, the anion conductor is commercially available in the form of hydroxide or halide (usually chloride), and the anion conductors may be used in industrial water purification, metal separation or catalytic processes.

As an anion conductor, a polymer doped with metal hydroxide may generally be used, and specifically, poly(ethersulfone), polystyrene, vinyl polymer, poly(vinyl chloride), poly(vinylidene fluoride), poly(tetrafluoroethylene), poly(benzimidazole), or poly(ethylene glycol) doped with metal hydroxide may be used.

In addition, the polymer electrolyte membrane may mainly be a fluorine-based polymer electrolyte membrane mainly including a fluorine-based ion conductor, but a hydrocarbon-based polymer electrolyte membrane mainly including a hydrocarbon-based ion conductor can also be used.

The polymer electrolyte membrane may have defects on the surface. Defects can be physical, such as creases, splits, dents, tears, grooves, or surface irregularities due to folding.

When a catalyst layer is formed on a polymer electrolyte membrane having defects on the surface, the interface between the catalyst layer and the membrane becomes detached, the membrane-electrode interfacial resistance increases, and performance decreases.

A method for manufacturing a polymer electrolyte membrane according to an embodiment includes a pretreatment process to evenly control the surface of a polymer electrolyte membrane having physical defects. That is, before coating a composition for forming a catalyst layer on a polymer electrolyte membrane, a solvent is added to the polymer electrolyte membrane to cause swelling.

Any solvent that can expand hydrophilic chains and hydrophobic chains of the polymer electrolyte membrane to cause the polymer electrolyte membrane having hydrophilic channels to swell in all directions can be used as the solvent for swelling the polymer electrolyte membrane. For example, the solvent can include water, alcohol, an organic solvent, or a combination thereof.

The alcohol may include n-propyl alcohol (NPA), isopropyl alcohol (IPA), ethanol (EtOH), or mixtures thereof, and the organic solvent may include N-methylpyrrolidone (NMP), dimethylacetamide (DMAc), tetrahydrofuran (THF), or mixtures thereof.

The solvent for swelling the polymer electrolyte membrane may be appropriately selected and mixed depending on the type of the polymer electrolyte membrane, and a mixing ratio may also be appropriately controlled depending on the type of the polymer electrolyte membrane. For example, the mixed solvent may include more than 0 wt % and less than 100 wt %, or 25 wt % to 75 wt % of water and alcohol. For reference, when using the same amount of solvent, the swelling degree is higher when the composition of the mixed solvent is alcohol than when it is 100 wt % water.

The method of adding a solvent to the polymer electrolyte membrane may include immersing or impregnating the polymer electrolyte membrane in the solvent, or coating the solvent to one or both surfaces of the polymer electrolyte membrane. When coating the solvent, methods including spraying, steam spraying, bar coating, comma coating, slot die, screen printing, doctor blade, laminating, or a combination thereof may be used.

The time for swelling the polymer electrolyte membrane may be appropriately controlled depending on the type of solvent, and may be performed for, for example, 1 second to 30 seconds. If the swelling time is less than 1 second, expansion of the hydrophilic channels within the polymer surface may not occur, and if it exceeds 30 seconds, expansion of the hydrophilic channels may occur excessively, causing the existing morphology to be deformed.

The polymer electrolyte membrane may have a length increase of 1% to 20%, for example, 3% to 15% after swelling compared to its length before swelling. Additionally, the polymer electrolyte membrane may have a thickness increase of 1% to 20%, for example, 3% to 15% after swelling compared to its thickness before swelling.

The longitudinal or thickness direction swelling degree of a polymer electrolyte membrane can vary depending on the type and amount of solvent used and the type and thickness of the polymer electrolyte membrane.

The longitudinal direction of the polymer electrolyte membrane refers to a plane direction perpendicular to the thickness direction, and may mean either the machine direction (MD) or the transverse direction (TD) or both. At this time, the machine direction means a direction in which the rolls travel when the polymer electrolyte membrane is continuously produced in a roll-to-roll manner or a direction in which the manufactured polymer electrolyte membrane is wound.

$$Swelling ( \% ) may be calculated by ( dimension after swelling - dimension before swelling ) / dimension before swelling \times 100.$$

The injection amount of the solvent that swells the polymer electrolyte membrane may be appropriately controlled depending on the mixed composition of the solvent, and may be injected at, for example, 0.4 mg/cm² to 6.8 mg/cm².

When the swelling degree is less than 1%, expansion of hydrophilic channels within the polymer surface may not occur, and when the swelling degree exceeds 20% and expansion of hydrophilic channels occurs excessively, the existing morphology may be deformed. Therefore, the swelling degree may be controlled from 1% to 20%.

Next, heat and pressure are applied to the swollen polymer electrolyte membrane.

In the applying heat and pressure, deterioration of the polymer electrolyte membrane may be prevented by controlling the swollen polymer electrolyte membrane with instantaneous heat and pressure. That is, when instantaneous heat and pressure are applied, the generated water vapor exists in the space between the press and the membrane, which can prevent deterioration of the polymer electrolyte membrane due to the Leidenfrost phenomenon.

Accordingly, the applying of heat and pressure may be performed for 1 to 30 seconds, for example, for 1 to 10 seconds.

If the thermocompression time for applying heat and pressure is less than 1 second, sufficient heat transfer may not occur, and a drying rate may not reach 100%. If it exceeds 30 seconds, the polymer electrolyte membrane may deteriorate depending on the heat treatment temperature, and this may cause performance degradation due to crosslinking between polymer chains.

The applying of heat and pressure may be performed at a temperature of about 20% of the intrinsic glass transition temperature (Tg) of the polymer electrolyte membrane. Through this, heat and pressure may be simultaneously transferred according to the glass transition temperature (Tg), which is a unique characteristic of the polymer electrolyte membrane, to evenly control the physically defective surface of the polymer electrolyte membrane.

For example, the temperature at which heat and pressure are applied may be a temperature of 110° C. to 130° C., or 115° C. to 125° C. If the temperature at which heat and pressure are applied is less than 110° C., chain changes in the polymer may not be induced due to heat transfer below the glass transition temperature, and if it exceeds 130° C., deterioration of the polymer electrolyte membrane may occur, and the surface and interior of the membrane may harden.

The applying of heat and pressure may be accomplished by applying a pressure of 50 kg/cm² to 200 kg/cm². If the pressure applying heat and pressure is less than 50 kg/cm², it may be difficult to remove surface defects of the polymer electrolyte membrane and it may be difficult to control swelling of the membrane, and if it exceeds 200 kg/cm², deterioration of the polymer electrolyte membrane may occur and a change in the thickness of the membrane may occur.

The degree of deterioration in the hydrogen ionic conductivity of the polymer electrolyte membrane before and after applying heat and pressure can be less than 5%, and for example, less than 2% is appropriate. The method for measuring the hydrogen ionic conductivity of the polymer electrolyte membrane is not particularly limited in the present invention, and the hydrogen ionic conductivity may be measured using the same method and conditions for the polymer electrolyte membrane before and after the applying of heat and pressure. If the degree of deterioration of the polymer electrolyte membrane exceeds 5%, sufficient proton transfer may become difficult, which may deteriorate the performance of the fuel cell.

Meanwhile, the method for manufacturing a polymer electrolyte membrane may further include mechanically stretching the polymer electrolyte membrane. If surface defects of a polymer electrolyte membrane are not sufficiently controlled by simply applying heat and pressure to the polymer electrolyte membrane, the defects may be additionally controlled through mechanical stretching.

For example, mechanical stretching may be achieved by applying tension in the machine direction (MD) while transporting the polymer electrolyte membrane using roll-to-roll equipment, and tension may be applied not only in the machine direction but also in the transverse direction (TD) perpendicular to the machine direction.

A method for manufacturing a membrane-electrode assembly according to another embodiment includes coating a composition for forming a catalyst layer on one or both surfaces of a polymer electrolyte membrane having controlled surface defects.

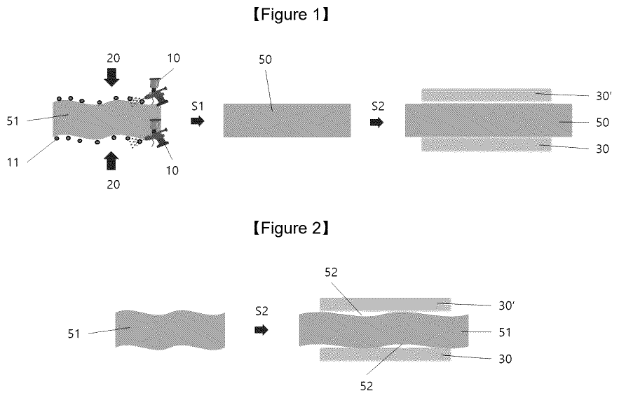

FIG. 1 is a view showing a manufacturing process of a membrane-electrode assembly according to another embodiment and FIG. 2 is a view showing a manufacturing process of a membrane-electrode assembly according to the prior art.

Referring to FIG. 2, when a decal process is performed at high temperature and pressure (S2) to form catalyst layers 30 and 30′ while the surface of the polymer electrolyte membrane 51 is uneven, the interface 52 between the catalyst layers 30 and 30′ and the polymer electrolyte membrane 51 is detached, increasing the membrane-electrode interfacial resistance and decreasing performance.

On the other hand, as shown in FIG. 1, by applying a solvent 11 using a spray 10 or the like to a polymer electrolyte membrane 51 having a defect on the surface to cause swelling, and applying instantaneous heat and pressure 20 to the swollen polymer electrolyte membrane 51 (S1), the surface can be evenly controlled while preventing deterioration of the polymer electrolyte membrane 50. Thereafter, when catalyst layers 30 and 30′ is formed on the surface of a polymer electrolyte membrane 50 whose surface is evenly controlled (S2), the interfacial resistance between the polymer electrolyte membrane and the electrode is lowered, thereby improving excellent cell performance and physical stability of the MEA for long-term operation.

A composition for forming a catalyst layer may be prepared by mixing a catalyst, an ionomer, and a solvent.

Any catalyst that can be used as a catalyst for hydrogen oxidation reaction or oxygen reduction reaction may be used, and a platinum metal is preferably used.

The platinum-based metal may include one selected from the group consisting of platinum (Pt), palladium (Pd), ruthenium (Ru), iridium (Ir), osmium (Os), a platinum-M alloy (M is at least one selected from the group consisting of palladium (Pd), ruthenium (Ru), iridium (Ir), osmium (Os), gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), lanthanum (La), and rhodium (Rh)), a non-platinum alloy, and a combination thereof, more preferably, a combination of two or more metals selected from the group of platinum-based catalyst metals may be used, but is not limited thereto, and any platinum-based catalyst metal usable in the present technical field may be used without limitation.

Specifically, the platinum alloy may be used alone or in combination of two or more selected from the group consisting of Pt—Pd, Pt—Sn, Pt—Mo, Pt—Cr, Pt—W, Pt—Ru, Pt—Ni, Pt—Ru—W, Pt—Ru—Ni, Pt—Ru—Mo, Pt—Ru—Rh—Ni, Pt—Ru—Sn—W, Pt—Ru—Ir—Ni, Pt—Co, Pt—Co—Mn, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, Pt—Cr—Ir, and a combination thereof.

In addition, the non-platinum alloy may be used alone or in combination of two or more selected from the group consisting of Ir—Fe, Ir—Ru, Ir—Os, Co—Fe, Co—Ru, Co—Os, Rh—Fe, Rh—Ru, Rh—Os, Ir—Ru—Fe, Ir—Ru—Os, Rh—Ru—Fe, Rh—Ru—Os, Fe—N, Fe—P, Co—N, and a combination thereof.

Additionally, the catalyst may be the metal itself (black) or may be used by supporting the catalytic metal on a carrier.

The carrier may be selected from a carbon-based carrier, a porous inorganic oxide such as zirconia, alumina, titania, silica, and ceria, and zeolite. The carbon-based carrier may be selected from, but is not limited to, graphite, Super P, carbon fiber, carbon sheet, carbon black, Ketjen Black, Denka black, acetylene black, carbon nanotube (CNT), carbon sphere, carbon ribbon, fullerene, activated carbon, carbon nanofiber, carbon nanowire, carbon nanoball, carbon nanohorn, carbon nanocage, carbon nanoring, ordered nano-/meso-porous carbon, carbon aerogel, mesoporous carbon, graphene, stabilized carbon, activated carbon, and a combination of one or more thereof, and any carrier usable in the present technical field may be used without limitation.

The catalyst may be located on the surface of the carrier, or may penetrate into the carrier by filling the internal pores of the carrier.

When using a precious metal supported on a carrier as a catalyst, a commercially available one may be used, or a catalyst manufactured by supporting the precious metal on a carrier may be used. The process of supporting a precious metal on a carrier is widely known in the art, and thus a detailed description thereof is omitted in this specification, but it is content that can be easily understood by those working in the art.

The catalyst may be included in the composition for forming a catalyst layer in an amount of 20 wt % to 80 wt % based on a total weight of the catalyst layer. If the content of the catalyst is less than 20 wt % based on the total weight of the catalyst layer, the activity may decrease, and if it exceeds 80 wt %, the active area may decrease due to agglomeration of the catalyst, which may conversely decrease the catalytic activity.

The composition for forming a catalyst layer includes an ion conductor to improve the adhesion of the catalyst and transfer protons. The ionomer used as a representative polymer ion conductor may be any one selected from the group consisting of a fluorine-based ionomer, a hydrocarbon-based ionomer, and a mixture thereof.

The fluorine-based ionomer may include a fluorinated polymer having a cation exchange group capable of transferring a cation such as a proton, or an anion exchange group capable of transferring anions such as a hydroxy ion, carbonate, or bicarbonate, and including fluorine in the main chain; or a partially fluorinated polymer such as a polystyrene-graft-ethylenetetrafluoroethylene copolymer, or a polystyrene-graft-polytetrafluoroethylene copolymer; and specific examples thereof may include a fluorinated polymer including poly(perfluorosulfonic acid), poly(perfluorocarboxylic acid), a copolymer of tetrafluoroethylene and fluorovinyl ether including a sulfonic acid group, a defluorinated sulfurized polyether ketone, or a mixture thereof. The cation exchange group may be any one selected from the group consisting of a sulfonic acid group, a carboxyl group, a boronic acid group, a phosphoric acid group, an imide group, a sulfonimide group, a sulfonamide group and a combination thereof, and may typically be a sulfonic acid group or a carboxyl group. Additionally, the fluorine-based ionomer may be used alone or in combination of two or more types.

In addition, the hydrocarbon-based ionomer may have a cation exchange group capable of transferring a cation such as a proton, or an anion exchange group capable of transferring an anion such as a hydroxyl ion, carbonate, or bicarbonate, and may include a hydrocarbon-based polymer such as imidazole, benzimidazole, polyamide, polyamideimide, polyimide, polyacetal, polyethylene, polypropylene, acrylic resin, polyester, polysulfone, polyether, polyetherimide, polyester, polyethersulfone, polyetherimide, polycarbonate, polystyrene, polyphenylene sulfide, polyetheretherketone, polyetherketone, polyarylethersulfone, polyphosphazene or polyphenylquinoxaline in the main chain, and specific examples thereof may include sulfonated polyimide (S-PI), sulfonated polyarylethersulfone, sulfonated polyetheretherketone (SPEEK), sulfonated polybenzimidazole (SPBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated Examples of hydrocarbon polymers include, but are not limited to, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, and a mixture thereof. Additionally, hydrocarbon-based ionomer may be used alone or in a combination of two or more types.

The ionomer may be included in the composition for forming a catalyst layer in an amount of 20 wt % to 45 wt %, and specifically 25 wt % to 38 wt % based on the total weight of the catalyst layer. If the ionomer content is less than 20 wt % based on the total weight of the catalyst layer, the performance of the fuel cell may deteriorate, and if it exceeds 45 wt %, excessive ionomer content may cause cohesion between ionomers.

The solvent may be a solvent selected from the group consisting of water, a hydrophilic solvent, an organic solvent, and a mixture of one or more thereof.

The hydrophilic solvent may have at least one functional group selected from the group consisting of alcohols, ketones, aldehydes, carbonates, carboxylates, carboxylic acids, ethers and amides, each of which includes a linear or branched saturated or unsaturated hydrocarbon having 1 to 12 carbon atoms as a main chain, and which may include an alicyclic or aromatic cyclo compound as at least a part of the main chain. Specific examples may include alcohols such as methanol, ethanol, isopropyl alcohol, ethoxyethanol, n-propyl alcohol, butyl alcohol, 1,2-propanediol, 1-pentanol, 1.5-pentanediol, 1.9-nonanediol, etc.; ketones such as heptanone, octanone, etc.; aldehydes such as benzaldehyde, tolualdehyde, etc.; esters such as methyl pentanoate, ethyl-2-hydroxypropanoate, etc.; carboxylic acids such as pentanoic acid, heptanoic acid, etc.; ethers such as methoxybenzene, dimethoxypropane, etc.; amides such as propanamide, butylamide, dimethylacetamide, etc.

The organic solvent may be selected from N-methylpyrrolidone, dimethyl sulfoxide, tetrahydrofuran, and a mixture thereof.

The solvent may be included in an amount of 80 to 95 wt % based on the total weight of the composition for forming a catalyst layer. If it is less than 80 wt %, the solid content may be too high, making dispersion difficult due to cracks and high viscosity during catalyst layer coating and if it exceeds 95 wt %, it may be detrimental to the activity of the catalyst layer.

A catalyst layer is formed by applying a composition for forming a catalyst layer manufactured on the surface of a polymer electrolyte membrane or a substrate.

When coating a composition for forming a catalyst layer directly onto a polymer electrolyte membrane, the composition for forming a catalyst layer in which a catalyst is dispersed may be continuously or intermittently transferred to a coater and then uniformly applied to a certain thickness on the polymer electrolyte membrane.

More specifically, depending on the viscosity of the composition for forming a catalyst layer, the composition may be continuously transferred to a coater such as a die, gravure, bar, or comma coater through a pump, and then applied using a method such as slot die coating, bar coating, comma coating, screen printing, spray coating, doctor blade coating, or brush.

Finally, the polymer electrolyte membrane to which the composition for forming a catalyst layer is coated is dried. The solvent remaining in the coated composition for forming a catalyst layer and the polymer electrolyte membrane is removed through a drying process.

The drying may be done using various drying methods such as hot air drying, vacuum drying, and infrared (IR) drying, and the drying temperature and time may be appropriately adjusted depending on the boiling point (BP) of the solvent used. Specifically, the drying temperature may be 60° C. to 150° C. for 0.5 to 10 hours.

### Mode for Invention

Below, specific examples of the present invention are presented. However, the examples described below are only intended to specifically illustrate or explain the present invention, and the present invention is not limited thereto. In addition, any content not described herein is omitted as it can be sufficiently technically inferred by a person skilled in the art.

### Manufacturing Example: Manufacturing of Membrane-Electrode Assembly

### Example 1

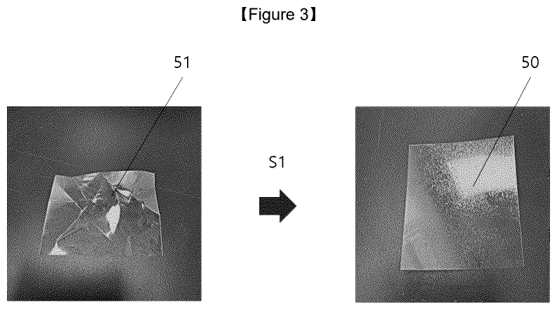

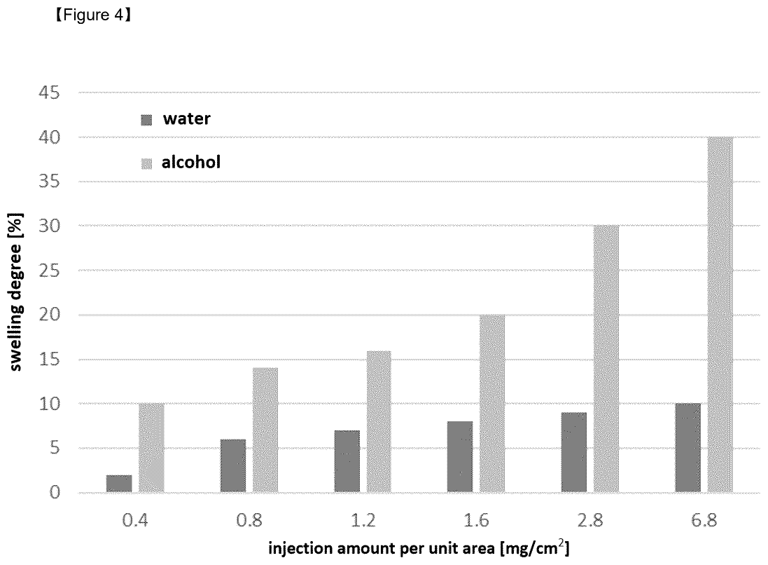

As shown in FIG. 3, a polymer electrolyte membrane including physical defects on the surface (NRE211, DuPont Co., USA) was swollen to a thickness direction swelling degree of 5% at room temperature by spraying a mixed solution of n-propylalcohol (NPA) and water (50:50 wt. %) at 0.4 mg/cm² per unit area for 2 seconds onto the surface of the polymer electrolyte membrane.

The swollen polymer electrolyte membrane was placed in an oven preheated to 120° C., which is a glass transition temperature (Tg) of the polymer electrolyte membrane, and then, instantly pressed at a pressure of 120 kg/cm² for 2 seconds to remove the defects on the surface of the polymer electrolyte membrane.

An anode including a Pt/C catalyst in a catalyst loading amount of 0.15 mg_{Pt}/cm² was manufactured in a decal method. A Nafion ionomer (5 wt % Nafion Dispersion, DuPont Co., USA) was used, wherein an ionomer/carbon ratio was 0.9.

A cathode including a Pt/C catalyst in a catalyst loading amount of 0.35 mgPt/cm² was manufactured in the decal method. A Nafion ionomer (5 wt % Nafion Dispersion, DuPont Co., USA) was used, wherein an ionomer/carbon ratio was 0.9.

The anode and the cathode were positioned on both sides of the polymer electrolyte membrane of which the defects on the surface were controlled and then, pressed at 150° C. for 10 minutes with a pressure of 30 bar, manufacturing a membrane-electrode assembly (MEA).

### Example 2

As shown in FIG. 3, a polymer electrolyte membrane including physical defects on the surface (NRE211, DuPont Co., USA) was swollen to a thickness direction swelling degree of 8% at room temperature by steam-spraying a mixed solution of n-propylalcohol (NPA) and water (75:25 wt. %) at 0.4 mg/cm² per unit area for 2 seconds onto the surface of the polymer electrolyte membrane.

The swollen polymer electrolyte membrane was passed through a roller preheated to 120° C., which is a glass transition temperature (Tg) of the polymer electrolyte membrane, and then, instantly pressed at a pressure of 120 kg/cm² for 2 seconds to remove the defects on the surface of the polymer electrolyte membrane.

An anode including a Pt/C catalyst in a catalyst loading amount of 0.15 mg_{Pt}/cm² with a Pt/C catalyst was manufactured in the decal method. A Nafion ionomer (5 wt % Nafion Dispersion, DuPont Co., USA) was used, wherein an ionomer/carbon ratio was 0.9.

A cathode including a Pt/C catalyst in a catalyst loading amount of 0.35 mgPt/cm² was manufactured in the decal method. A Nafion ionomer (5 wt % Nafion Dispersion, DuPont Co., USA) was used, wherein an ionomer/carbon ratio was 0.9.

The anode and the cathode were positioned on both sides of the polymer electrolyte membrane of which the defects on the surface were controlled and then, pressed at 150° C. for 10 minutes with a pressure of 30 bar, manufacturing a membrane-electrode assembly (MEA).

### Comparative Example 1

An anode including a Pt/C catalyst in a catalyst loading amount of 0.15 mg_{Pt}/cm² was manufactured in the decal method. A Nafion ionomer (5 wt % Nafion Dispersion, DuPont Co., USA) was used, wherein an ionomer/carbon ratio was 0.9.

A cathode including a Pt/C catalyst in a catalyst loading amount of a catalyst loading amount of 0.35 mgPt/cm² was manufactured in a decal method. A Nafion ionomer (5 wt % Nafion Dispersion, DuPont Co., USA) was used, and an ionomer/carbon ratio was 0.9.

The anode and the cathode were positioned on both sides of a polymer electrolyte membrane (NRE211, DuPont Co., USA) including defects on the surface and then, pressed at 150° C. for 10 minutes with a pressure of 30 bar, manufacturing a membrane-electrode assembly (MEA).

### Experimental Example 1: Measurement of Changes in Swelling and Drying Rate According to Changes in Process Conditions

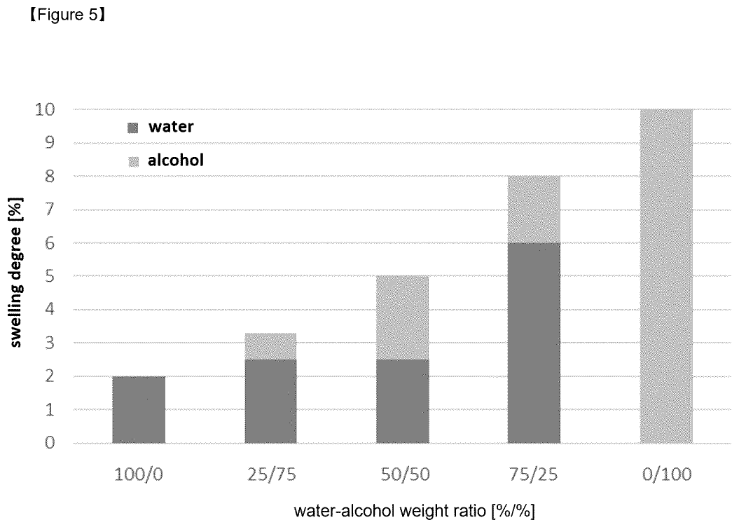

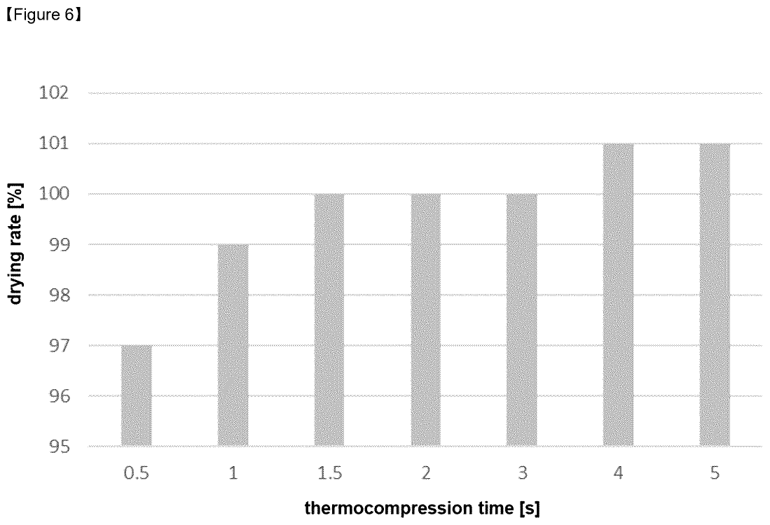

In Example 1, a change in the thickness direction swelling degree of the polymer electrolyte membrane by changing the amounts of the solvents injected thereinto were measured, and the results are shown in FIG. 4.

Referring to FIG. 4, as the amounts of the solvents injected thereinto were increased in both water and alcohol, the thickness direction swelling degree of the polymer electrolyte membrane also increased.

In addition, a change in the thickness direction swelling degree of the polymer electrolyte membrane by changing the solvent ratio in Example 1 was measured, and the results are shown in FIG. 5.

Referring to FIG. 5, if the solvents were used in the same amounts, the thickness direction swelling degree of the polymer electrolyte membrane was higher when alcohol was 100 wt % than when water was 100 wt %.

In addition, as the thermocompression time was changed, the polymer electrolyte membrane in Example 1 was measured with respect to a drying rate, and the results are shown in FIG. 5.

Referring to FIG. 5, as the thermocompression time was changed, the drying rate of the polymer electrolyte membrane increased, wherein when the thermocompression time was 1 second or longer, the drying rate was near 100% due to sufficient heat transfer.

### Experimental Example 2: Interface Measurement of Membrane-Electrode Assembly

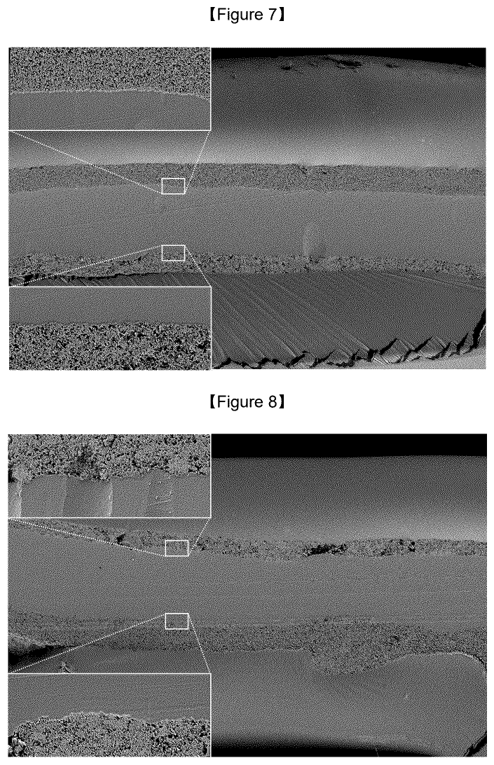

The membrane-electrode assemblies of Example 1 and Comparative Example 1 were respectively taken a scanning electron microscope (SEM) photograph of on the interface with a catalyst layer, which are shown in FIGS. 7 and 8.

Referring to FIGS. 7 and 8, the membrane-electrode assembly of Example 1 had a flat interface between polymer electrolyte membrane and electrode and thus low interfacial resistance, as the catalyst layer was formed after controlling the surface defects, but the membrane-electrode assembly of Comparative Example 1 was manufactured by using a polymer electrolyte membrane with surface defects and thus had an uneven interface between polymer electrolyte membrane and electrode, wherein the interface between catalyst layer and polymer electrolyte membrane was excited, increasing membrane-electrode interfacial resistance and deteriorating performance.

### Experimental Example 3: Performance Evaluation of Membrane-Electrode Assembly

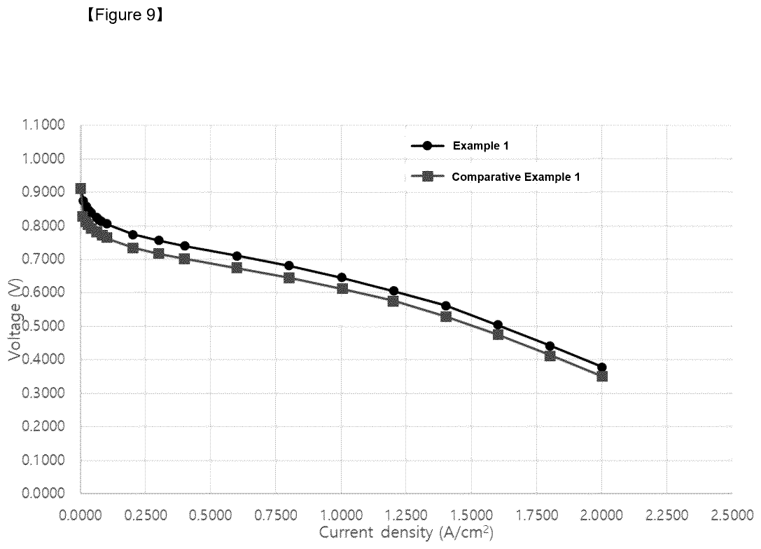

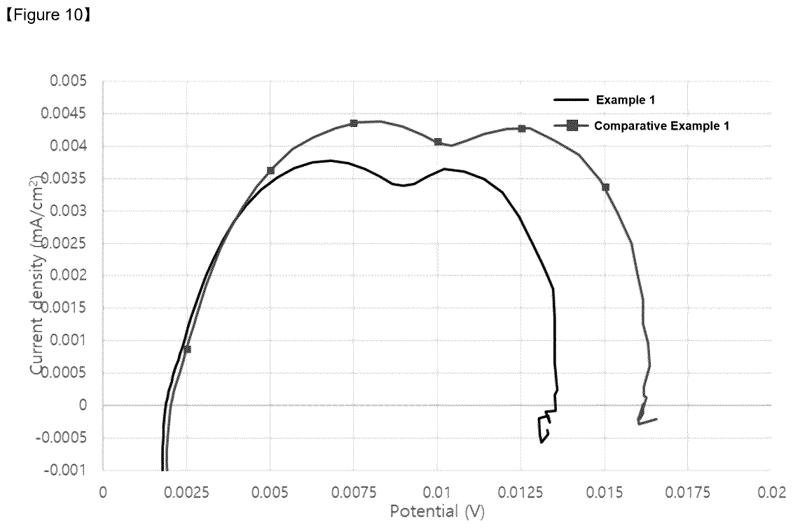

The membrane-electrode assemblies of Example 1 and Comparative Example 1 were measured with respect to performance, and the results are shown in FIGS. 9 and 10.

FIG. 9 is a current density-voltage graph of the membrane electrode assemblies manufactured in Example 1 and Comparative Example 1, and FIG. 10 is a potential-current density graph of the membrane-electrode assemblies manufactured in Example 1 and Comparative Example 1.

A cell voltage (V) was measured under the conditions of a cell temperature of 65° C., SR (A/C) of 1.5/2.0, RH (A/C) of 100/100 (%), and an operating pressure (Barₐ, A/C) of 1/1, and EIS (electrochemical impedance spectroscopy, Ω) was measured under the conditions of a cell temperature of 65° C., SR (A/C) of 1.5/2.0, RH (A/C) of 50/50 (%), and an operating pressure (Barₐ, A/C) of 1/1. Herein, SR is a stoichiometry ratio, and A/C is anode/cathode, which is expressed as an amount ratio of fuel supplied to each electrode according to the stoichiometric ratio.

Referring to FIGS. 9 and 10, in Example 1, the membrane-electrode assembly, in which a catalyst layer was formed after controlling the surface defects, was confirmed to have low interfacial resistance between polymer electrolyte membrane and electrode and thus exhibit excellent cell performance, compared with the membrane-electrode assembly of Comparative Example 1.

Although the preferred embodiments of the present invention have been described in detail above, the above-described embodiments are presented as specific examples of the present invention, and the present invention is not limited thereby, and the scope of the present invention includes various modifications and improvements made by those skilled in the art using the basic concept of the present invention defined in the claims to be described later.

### DESCRIPTION OF SYMBOLS

10: spray
11: solvent
20: heat and pressure
30, 30′: catalyst layer
50: polymer electrolyte membrane with controlled surface defects
51: polymer electrolyte membrane having surface defects
52: interface

### INDUSTRIAL APPLICABILITY

The present invention relates to a method for manufacturing a polymer electrolyte membrane and a membrane electrode assembly, wherein the surface of a physically defective polymer electrolyte membrane is evenly controlled while preventing deterioration of the polymer electrolyte membrane, thereby lowering the interfacial resistance between the polymer electrolyte membrane and an electrode, and improving excellent cell performance and the physical stability of the MEA during long-term operation.

1. A method for manufacturing a polymer electrolyte membrane, comprising applying a solvent to a polymer electrolyte membrane having defects on the surface thereof to swell the polymer electrolyte membrane, and applying heat and pressure to the swollen polymer electrolyte membrane.

2. The method for manufacturing a polymer electrolyte membrane of claim 1, wherein
the solvent includes water, alcohol, an organic solvent, or a combination thereof.

3. The method for manufacturing a polymer electrolyte membrane of claim 2, wherein
the solvent includes greater than 0 wt % and less than 100 wt % of water and more than 0 wt % and less than 100 wt % of alcohol.

4. The method for manufacturing a polymer electrolyte membrane of claim 1, wherein
the method for applying the solvent to the polymer electrolyte membrane includes spraying, steam spraying, or a combination thereof.

5. The method for manufacturing a polymer electrolyte membrane of claim 1, wherein
the swelling is performed in 1 to 30 seconds.

6. The method for manufacturing a polymer electrolyte membrane of claim 1, wherein
the polymer electrolyte membrane has an increase in length by 1% to 20% after swelling compared to its length before swelling.

7. The method for manufacturing a polymer electrolyte membrane of claim 1, wherein
the polymer electrolyte membrane has a thickness increase of 1% to 20% after swelling compared to the thickness before swelling.

8. The method for manufacturing a polymer electrolyte membrane of claim 1, wherein
the applying of heat and pressure is performed for 1 to 30 seconds.

9. The method for manufacturing a polymer electrolyte membrane of claim 1, wherein
the applying of heat and pressure is performed at a temperature of about 20% of an intrinsic glass transition temperature (Tg) of the polymer electrolyte membrane.

10. The method for manufacturing a polymer electrolyte membrane of claim 9, wherein
the applying of heat and pressure is performed at a temperature of 110° C. to 130 ° C.

11. The method for manufacturing a polymer electrolyte membrane of claim 1, wherein
the applying of heat and pressure is accomplished by applying a pressure of 50 kg/cm² to 200 kg/cm².

12. The method for manufacturing a polymer electrolyte membrane of claim 1, wherein
a degree of deterioration in hydrogen ion conductivity of the polymer electrolyte membrane is less than 5% before and after applying heat and pressure.

13. A method for manufacturing a membrane-electrode assembly, comprising
coating a composition for forming a catalyst layer on one or both surfaces of the polymer electrolyte membrane manufactured by the method of claim 1.
